(19) United States
(12) Patent Application Publication
(10) Pub. No.: US 2008/0184992 A1
(43) Pub. Date: Aug. 7, 2008

(54) Hard Caramels with Isomal Tulose

(76) Inventors: Margit Arenz, Nehren (DE); Jorg Bernard, Albsheim (DE); Jorg Kowalczyk, Eisenberg/Steinborn (DE)

Correspondence Address: DICKSTEIN SHAPIRO LLP, 1177 AVENUE OF THE AMERICAS (6TH AVENUE), NEW YORK, NY, 10036-2714, US

(21) Appl. No.: 11/914,037

(22) PCT Filed: May 11, 2006
(86) PCT No.: PCT/EP06/04418

§ 371 Date: Jan. 25, 2008

(30) Foreign Application Priority Data
May 11, 2005 (DE) 10 2005 022 601.9

(51) Int. Cl. C13F 3/00; C13F 1/00

(52) U.S. Cl. 127/30; 127/46.1

(57) ABSTRACT

The invention relates to hard caramels and hard caramel masses containing a predominant fraction of isomaltulose, i.e. Palatinose™, methods for their production, and the use of isomaltulose as constituent of a hard caramel.

The present invention relates to hard caramels and hard caramel masses which contain a predominant fraction of isomaltulose, i.e. palatinose™, methods for their production, and the use of isomaltulose as a constituent of a hard caramel.

Known hard caramels usually contain as constituents saccharides, such as sucrose, glucose, but also malt syrup, fructose, isomaltose, meso-erythritol or hydrated isomaltulose, i.e. a mixture of 6-O-α-D-glucopyranosyl-D-sorbitol (1,6-GPS) and the stereoisomeric 1-O-α-D-glucopyranosyl-D-mannitol (1,1-GPM), and, if applicable, trehalulose. Caramels without sugar, such as sucrose or glucose, and with tooth-preserving or low energy constituents continue to gain in significance. Tooth-preserving sugars cannot be utilized as substrate by the microorganisms of the oral flora; no acids are generated that may destroy the dental enamel. Moreover, there is a great need for “low energy” hard caramels made up of constituents providing no or only a small fraction of energy in a form that can be utilized by the body, but at the same time possess technologically desired properties (so-called filling agents or “bulk substances”).

Hard caramels contain the saccharides specified above essentially in amorphous form, i.e. not in crystalline form. An essential aspect of the storage of hard caramels is the prevention of re-crystallization, during which recrystallized areas form mainly on the surface of the hard caramels or opaquenesses occur in the hard caramels. Often, undesirable uptake of water from the surroundings occurs during storage. Phenomena of this type are undesirable since they may have a detrimental effect on the marketability of the caramels and on their sensory properties during flavor tests.

DE 195 32 396 C2 discloses tooth-preserving, low energy hard caramels containing a 1,6-GPS- or 1,1-GPM-fortified mixture. A 1,1-GPM-fortified mixture is taken to mean a mixture of 1,6-GPS and 1,1-GPM comprising 1,6-GPS/1,1-GPM at a ratio of 1/99% by weight to 43/57% by weight, i.e. contains 57 to 99% by weight 1,1-GPM. The actually disclosed hard caramels comprise a 1,1-GPM content of 85% by weight. Hard caramels of this type tend to recrystallize during extended storage.

EP 1 217 898 B1 discloses tooth-preserving, low energy hard caramels with a 1,1-GPM content of 52 to 60% by weight and a sorbitol content of 0.5 to 3.5% by weight. Hard caramels of this type are characterized by their improved stability during storage (shelf-life), i.e. reduced recrystallization tendency and/or reduced water uptake. However, as a disadvantage the hard caramels referred to above have a rougher surface and are considered to be unattractive by the consumer, especially because of the setting of a certain 1,1-GPM content. Just as unattractive in terms of their sensory properties are hard caramels with an excessively smooth surface. Also unattractive to the consumer is the observation that the dissolution of hard caramels containing 1,1-GPM in the mouth, i.e. their consumption, tends to lead to a feeling of roughness developing, which is likely due to recrystallization of the 1,1-GPM.

Moreover, a number of known, in particular tooth-preserving or low energy, hard caramels contain constituents with a negative heat of solution. This generates a “cooling effect” in flavor tests that may be quite desirable for some products, such as sweets with peppermint or menthol aroma. However, in other products, for example chocolate, vanilla or caramel aroma, effects of this type are, at least to some extent, undesirable and may lead to non-acceptance by the consumer.

EP 1 217 898 B1 teaches that the storage stability of hard caramels can be improved by the hard caramels containing at least one acid. However, this approach to a solution can be described only when hard caramels are to be obtained which have an inherent acidic flavor or, in the case of buffered acids, if the flavor of the buffered acid is tolerable. However, there is also a need for hard caramels whose storage stability is as high as possible without the presence of an acid, for example special formulas with alkaline constituents, such as alkaline salts, and/or with constituents that are not acid-stable.

Therefore, there continues to be a need for, in particular tooth-preserving or low energy, hard caramels whose storage stability is as high as possible, even under unfavorable climatic conditions such as high humidity and high ambient temperature, and which are found to be attractive by the consumer not only in terms of their visual appearance, but also their sensory properties, i.e. which show no or little recrystallization of the components contained therein, have no more than low surface roughness or, even better, no noticeable surface roughness and/or none of the, to some extent, undesirable “cooling effect”. In particular, they are to be associated with un-changing or improved attractiveness in terms of their sensory properties and/or improved organoleptic sensation. Moreover, the hard caramels should have an unchanging or improved storage stability in the absence of acids (acids for consumption) as a further constituent.

The technical problem underlying the present invention thus is to provide hard caramels that are improved as described above, as well as methods and means for their production.

This technical problem is essentially solved by providing a hard caramel comprising an isomaltulose fraction of 60 to 100% by weight, preferably of 80 to 98% by weight.

In the context of the invention, numbers stated in units of % by weight always relate to the total dry substance of the hard caramel, unless evident otherwise.

Isomaltulose is a sugar, that is also known under the brand name, Palatinose™. Chemically, isomaltulose is alpha-1,6-glycosidically-linked glucose and fructose: 6-O-α-D-glucopyranosyl-D-fructose. Isomaltulose is an isomer of sucrose, small amounts of which occur naturally, that can usually be obtained from sucrose by technical means by enzymatic conversion. Its sweetening power is only approx. 40% of the sweetening power of sucrose. Isomaltulose contains fewer calories than sucrose and is non-cariogenic (i.e. not caries-eliciting). This is because the bacteria of the oral flora cannot convert isomaltulose into tooth-damaging acids. Moreover, isomaltulose prevents the adhesion of plaque-forming bacteria on the teeth and thus also prevents the formation of plaques and tartar.

Accordingly, the invention provides the teaching according to which a hard caramel can be provided that has particularly high storage stability and preferably particularly attractive sensory properties and that is preferably essentially acid-free, if the hard caramel comprises an isomaltulose content of more than 50% by weight, according to the invention of 60 to 100% by weight, preferably of 80 to 98% by weight. The invention adds to the prior art in that it showed that an isomaltulose fraction of 60 to 100% by weight, preferably of 80 to 98% by weight affords particularly advantageous hard caramels.

However, a further preferred object of the invention are hard caramels with a certain isomaltulose content; this content is selected depending on the field of application and desired advantages. It is preferably more than: 60, 65, 70, 75, 80, 85, 90, 95, 98 or 99% by weight.

Another object of the invention is a melt or hard caramel mass, preferably for producing hard caramels according to the invention. Preferably, this melt or hard caramel mass contains an isomaltulose fraction identical to that of the hard caramel according to the invention itself, i.e. preferably of 60 to 100% by weight, particularly preferably of 80 to 98% by weight. Further useful isomaltulose fractions in the formula can be selected according to the field of application, in particular more than: 60, 65, 70, 75, 80, 85, 90 or 95% by weight.

In a preferred embodiment, the hard caramel or melt is free or essentially free of acid. This means, it comprises only low fractions of free acids and/or acid salts of acids that a person skilled in the art would no longer consider them to be acid-containing hard caramels. Preferably, the hard caramel according to the invention comprises less than: 5%, 4%, 3%, 2%, 1%, 0.5%, 0.1%, 0.05%, 0.01% acid and/or acid salts.

In a further preferred embodiment, the hard caramel or melt is essentially free of fat. In a further embodiment, the hard caramel is essentially free of oil. Accordingly, in both cases the fraction of fat and/or oil of the hard caramel according to the invention is so low that a person skilled in the art would not consider it to be a fat- and/or oil-containing hard caramel. Preferably, the hard caramel according to the invention comprises less than: 5%, 4%, 3%, 2%, 1%, 0.5%, 0.1%, 0.05%, 0.01% fat and/or oil or fat- and/or oil-containing constituents.

Surprisingly, the hard caramel according to the invention are also characterized by their particularly low water uptake during storage. They show a significantly lower tendency to recrystallize, in particular when the water content of the caramel is high, i.e. more than 2%, preferably more than 3%. This improves their storing properties sub-stantially. It has thus been achieved that—at unchanged or improved storage stability—the water fraction of the hard caramels according to the invention can be higher than in known hard caramels. The inventors found surprisingly that the storage stability could be improved significantly, especially in the case of acid-free hard caramels.

In a particularly preferred embodiment, the hard caramel or melt according to the invention comprises a water content in excess of or equal to 2%, preferably in excess of or equal to 3%, immediately after its production (starting water content).

This surprising effect also allows in an advantageous fashion to reduce the exposure to heat that is required in the production of hard caramels to reduce the water content of the hard caramel mass. According to the invention, the water content of the hard caramels according to the invention can be higher than in known hard caramels that are stable on storage. This also allows for the use of particularly heat-sensitive constituents in the production of the hard caramel. In a particularly preferred embodiment, the hard caramels according to the invention thus contain constituents that could not be processed previously due to the high temperatures used in the production of hard caramels that are stable on storage.

In the context of the present invention, a hard caramel is taken to mean an essentially amorphous, glass-like product that can be produced by removing water by evaporation from an aqueous solution or suspension of a sweetener, for example a sugar substitute, such that the solution or suspension of the sugar substitute gets more concentrated in the process, and by shaping the concentrate as desired, for example by pouring or embossing. Hard caramels according to the invention can also be produced by melt extrusion of a dry sweetener mixture. Obviously, further constituents such as aroma, dyes, intensive sweetening means or similar, can, during its production, be added to the hard caramel which is also called glass body or hard caramel mass, provided it contains no constituents aside from body-providing sugar or sweetener.

In a particular embodiment, the hard caramel or hard caramel mass according to the invention comprises isomaltulose as the sole substitute of cariogenic sugars and/or as the sole sugar. In a further preferred embodiment, the hard caramel or hard caramel mass according to the invention comprises isomaltulose as the sole body-providing sweetening agent, in particular as the sole sweetening agent. In the context of the present invention, the term, “sweetening agent”, is taken to mean substances that possess sweetening power and are added, for example, to foods or beverages in order to produce a sweet flavor. In the context of the present invention, the “sweetening agents” shall be subdivided as “sugars”, such as sucrose, glucose or fructose, that provide body and sweetening power, and as “sweetening means”, i.e. substances that are not sugars but still possess sweetening power, with the latter being further subdivided as “sugar substitutes”, i.e. sweetening agents possessing a body and a physiological caloric value in addition to their sweetening power (body-providing sweetening means), and as “intensive sweetening means”, i.e. substances that usually have very high sweetening power, but no body and usually no or little physiological caloric value.

In a particularly preferred embodiment, the present hard caramel or hard caramel mass according to the invention is tooth-preserving, acariogenic and/or reduced in caloric value and/or reduced in calories.

In a further embodiment, the hard caramel or hard caramel mass according to the invention is free of intensive sweetening means. The hard caramel or hard caramel mass according to the invention can, as illustrated above, be suitable for diabetics and/or compatible with teeth; however, a further variant provides for sugars such as sucrose, glucose, maltose or similar, to be present in the caramel.

If applicable, the hard caramel or hard caramel mass contains additional auxiliary substances or additives such as additional sweeteners, for example sugar alcohols, sugar substitutes or intensive sweetening means, but also auxiliary substances or additives selected dyes, flavorings, aroma, food-compatible acids if applicable, preservatives, agents, filling agents, fats if applicable, fat substitutes, binding agents, mineral salts, containing for example Ca²⁺, NaCl, trisodiumcitrate, phosphate or Mg²⁺. Accordingly, a preferred caramel according to the invention contains sugar alcohols such as 1,6-GPS, 1,1-GPS, hydrated and non-hydrated starch hydrolysates (HSH), erythritol, xylitol, maltotriit, lactitol, maltodextrins and/or mannitol.

Preferably, at least one medically active substance with a prophylactic or therapeutic effect on the body of humans or animals is added to the hard caramel as agent, for example antihistamines, antibiotics, fungicides, microbicides, hexylresorcin, dextromethorphan hydrobromide, menthol, nicotine, caffeine, vitamins, zinc, eucalyptus, benzocaine, cetylpyridinium, fluorides, phenylpropanolamine or other pharmaceutically active substances. If used as medically active hard caramel, a quantity of, for example, 1.0 to 15 mg of the agent per unit can be contained therein.

The hard caramels can also contain aroma substances such as plant or fruit oils, citrus oils, blossom or leaf oils, oils from cherry, strawberry, menthol, eucalyptus, peppermint, honey or green mint, fruit essences, green tea extract or natural or synthetic dyes, etc. Preferably, a quantity of 0.05 to 3% by weight of the aroma substance specified above is added.

In a preferred embodiment of the invention, the hard caramels can also contain binding agents such as alginates, cellulose, gelatin or plant-derived rubber substances.

In order to increase the sweetening power, it can be provided to add intensive sweetening means to the hard caramels, for example aspartame, cyclamate, acesulfame-K, saccharine, sucralose, glycyrrhizine, monellin, dulcin, naringin-dihydrochalcone, neotame, alitame, neohesperidine DC (dihydrochalcone), stevioside, thaumatin or similar.

Synthetic or natural dyes can be used as dyes. For example, erythrosine, indigo carmine, Allurarot, E171, tartrazine, titanium dioxide or similar substance can be used as synthetic dye. Natural dyes can be carotinoids, for example betacarotene, riboflavins, chlorophyll, anthocyans, for example from red beet, betanin or similar substance. In the case of the use of synthetic dyes, typically 0.01 to 0.03% by weight of dye are used, whereas, in the case of natural dyes, preferably 0.1 to 1% by weight are used.

For example polydextrose or inulin can serve as filling agents. For example caprenin, salatrim or olestra can serve as fat substitutes.

Plant fats, for example non-hardened fats, or milk fat can be used as fats. The fats can also be contained in fat- or oil-containing products such as milk products, for example cream or butter, eggs, other fatty animal products and/or plant products to be added to the hard caramel.

In one variant, the hard caramel or hard caramel mass according to the invention contains at least one acid and/or one acid salt. Organic acids are preferable. As food-compatible organic acids, for example citric acid, malic acid, lactic acid, tartaric acid, ascorbic acid or food-compatible acids with similar effect can be used.

The hard caramels preferably contain a milk product, for example a dairy product such as whole milk powder, cream or butter. Preferably, a quantity of 0 to 9% by weight of milk products of this type can be present.

The hard caramels preferably also contain emulsifying agents such as lecithin, for example soy lecithin or similar substance, for example a quantity of 0 to 5% by weight thereof.

Accordingly, the invention also provides a hard caramel containing isomaltulose quantities according to the invention and in addition preferably consists of 1 to 90% by weight of further substances selected from the group consisting of intensive sweetening means, filling agents, flavorings or aroma substances, dyes, medically active constituents, food-compatible acids, fat substitutes, fat, dairy products and/or mineral salts and/or emulsifying agents.

The invention preferably relates to hard caramels containing quantities according to the invention of the sweetener or “bulking agent” isomaltulose, a quantity of 0.01 to 2.5% by weight of an aroma substance or flavoring, a quantity of 0.05 to 0.25% by weight of an intensive sweetening means, a quantity of 0.1 to 5.0% by weight (each relative to the total weight of the caramel) of an organic acid if applicable, and water. A further embodiment provides a hard caramel containing or consisting of isomaltulose, a quantity of 0.01 to 2.5% by weight of an aroma substance or flavoring, a quantity of 0.05 to 0.25% by weight of an intensive sweetening means, a quantity of 0.1 to 5.0% by weight of an organic acid if applicable, and, if applicable, a quantity of 0.1 to 10% by weight of a fat- or oil-containing component, a quantity of 0.01 to 2.5% by weight of an emulsifying agent, and water.

The hard caramels according to the invention can be provided in embossed or poured form and contain suitable fillings, if applicable, for example maltitol syrup. The invention further relates to hard caramels comprising a core and a, multi-layered or single-layered, coating. Preferably, solely the core (filling) contains isomaltulose. In a further preferred variant, solely the coating (cover) contains isomaltulose. In a further preferred variant, both the core (filling) and the coating (cover) contain isomaltulose. The filling can be present in solid or liquid form. The filling is not necessarily made of the hard caramel mass of the present invention. Rather, it can be provided to produce a hard caramel such that only its cover or coating is made of the hard caramel mass according to the invention, whereas the filling is made up of a different material, in particular a sugar-free material. In particular, the present invention relates to hard caramels consisting of or containing the hard caramel mass according to the invention. Accordingly, a filled hard caramel can be provided whose filling is of any type, for example contains a sugar-free sweetener, and whose cover consists of the hard caramel mass according to the invention.

However, the invention also relates to unfilled hard caramels consisting of the hard caramel mass according to the invention as specified above or containing this hard caramel mass and added additives as specified above.

The invention also relates to a method for producing the hard caramels or hard caramel mass according to the invention, whereby an aqueous solution or suspension, containing an educt mixture of the above-specified quantities of isomaltulose, for example from 60 to 100% by weight, is heated to temperatures of 120 to 145° C., evaporated, cooled down, and concentrated to a dry substance content of at least 95, 96, 97, 98 or 99% by weight. The isomaltulose fraction in the educt mixture can be more than: 60, 70, 80 or 90% by weight, depending on the application. Subsequently, the mixture is cooled down and shaped. The concentration step is advantageously carried out by evaporation of water by boiling and/or applying a vacuum, for example batch-wise or continuously.

According to the invention, it is preferred for the acid content of the aqueous solution or suspension to be very low, particularly preferably no acid is present at all. Preferably, the pH value of the solution/suspension is higher than or equal to pH 5, preferably higher than or equal to pH 7. Depending on the field of utilization, the following pH values are advantageous as lower limits: 4; 4.5; 5; 5.5; 6; 6.5; 7; 7.5; 8.

According to the present invention, the heat exposure temperature during the concentration step, particularly during the entire production procedure, is always 135° C. or less, preferably 130° C. or less. Obviously, the concentration step can also be carried out in generally known fashion and the heat exposure temperature can be higher than 135° C., for example from 145 to 170° C., without deviating from the teaching of the invention. Depending on the field of application and desired result, the heat exposure temperature during cooking is lower than or equal to: 125, 128, 130, 133, 135, 138 or 140° C.

The hard caramels can also be produced by means of melt extrusion in generally known fashion. Regardless of the production procedure, it is preferred according to the invention to keep the heat exposure temperature at 135° C. or less at all times, preferably at 130° C. or less at all times. However, it can also be higher than 135° C., for example from 145 to 170° C., without deviating from the teaching of the invention.

Accordingly, the invention also relates to hard caramels or hard caramel masses that can be, and preferably are, produced by means of the method according to the invention. Immediately after their production, these preferably have a water content of less than: 6, 5 or 4% by weight (relative to the total weight). Further, the water content preferably is not less than: 2, 3 or 4% by weight (relative to the total weight).

And lastly, the use of isomaltulose as constituent of a hard caramel for the purpose of improving the storage stability of the hard caramel, in particular for reducing the water uptake and/or recrystallization, is another object of the present invention.

Preferably, the use according to the invention applies to hard caramels that are essentially free of acid.

Moreover, the use according to the invention also applies to hard caramels with a high water content (starting water content). This content is preferably higher than or equal to 2%, preferably higher than or equal to 3%.

The storage stability was determined as part of the present invention by storing the hard caramels for three days in the open at 25° C. and 80% relative humidity. Seventy-two hours after the start of storage, the hard caramels were subjected to an evaluation, whereby, on the one hand, the extent of visibly detectable recrystallization, and, on the other hand, the stickiness of the hard caramel was evaluated.

Improved storage stability as part of the present invention is evident in particular, if reference caramels are rated to be poorer in terms of their visibly detectable recrystallization and/or their stickiness, in particular if the hard caramels according to the invention show a lesser extent of visibly detectable recrystallization and/or lesser extent of stickiness. Whereas sucrose-glucose glass bodies deliquesced to a syrup and the isomalt glass bodies clearly showed recrystallization during the storage tests, the isomaltulose glass bodies according to the invention did no recrystallize or only to a certain extent; however, the extent of recrystallization is always lower than in the glass bodies according to known formulas.

Moreover, the isomaltulose recovery in the stored glass bodies was determined. It is evident that the isomaltulose recovery was higher than or equal to 90% provided there was essentially no acid contained in the hard caramel.

Moreover, the flow properties of the isomaltulose mass during pouring is particularly advantageous similar to the flow properties of known sucrose-hard caramel masses. Accordingly, isomaltulose masses show similarly good processing properties as known hard caramel masses; the adaptation of further process parameters in the production of hard caramels is therefore essentially dispensable.

Further advantageous developments are evident from the dependent claims.

The invention shall be illustrated in more detail on the basis of the following examples and corresponding figures.

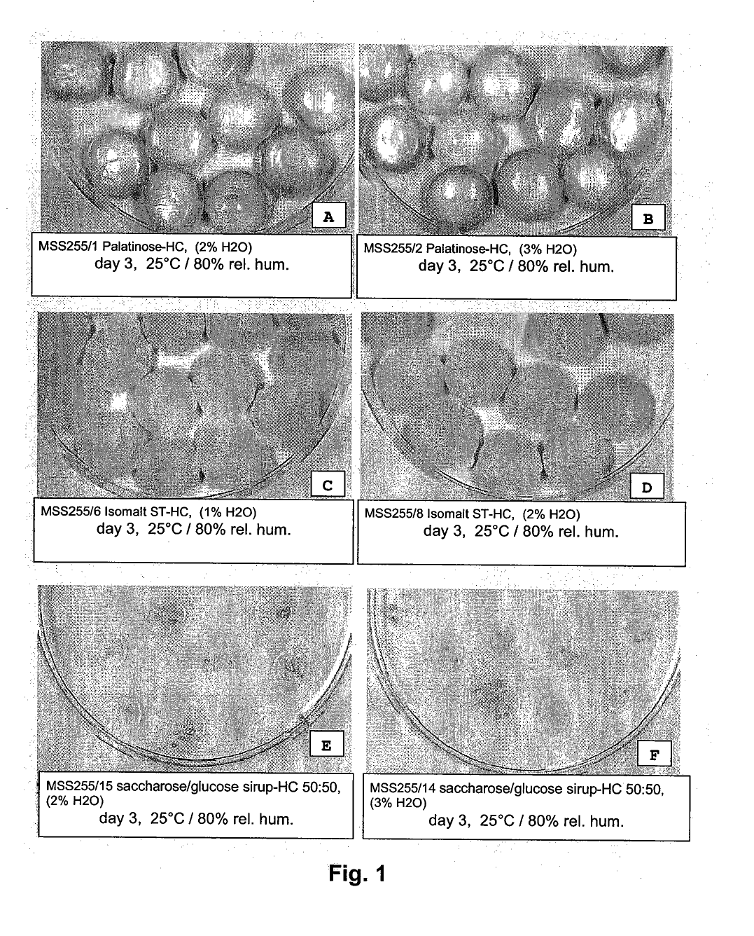

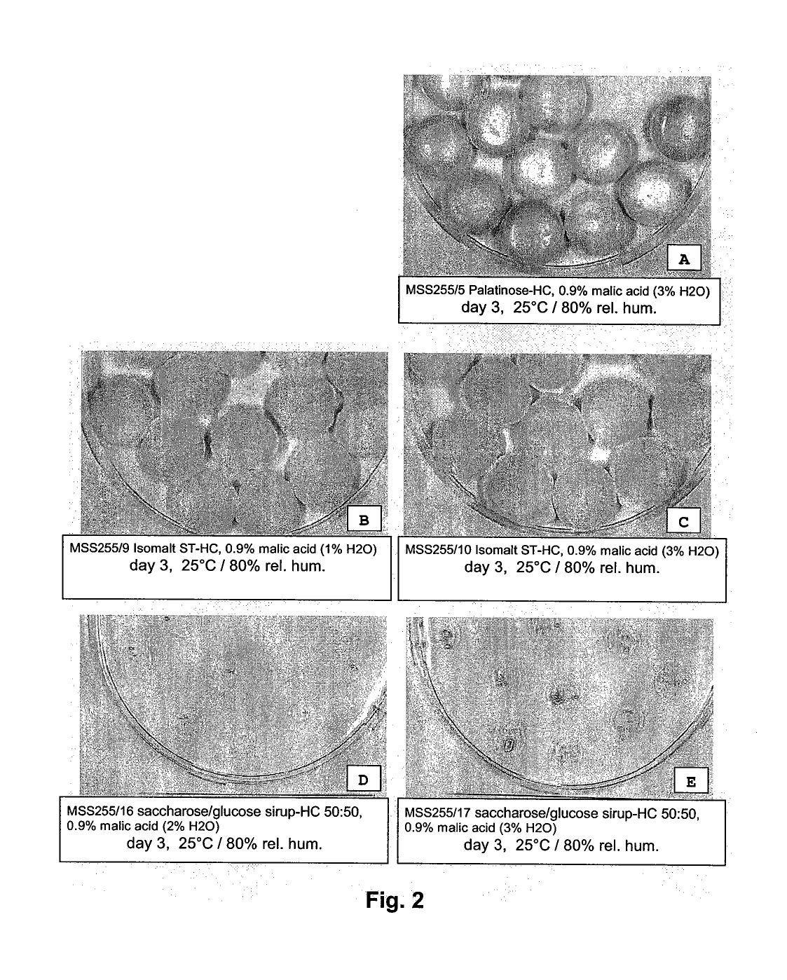

The FIGS. 1a, 1b, 1c, 1d, 1e, 1f, and FIGS. 2a, 2b, 2c, 2d, 2e show photographic images of hard caramels according to the invention as well as comparison hard caramels, each after 3 days of storage at 25° C. and 80% relative humidity.

### EXAMPLE 1

### Production of Hard Caramels/Glass Bodies

The following 3 groups of hard caramels are produced:

Group I: Isomaltulose glass body (according to the invention):

| | | |
|---|---|---|
| MS 255/1: | without acid | Water content approx. 2% |
| MS 255/2: | without acid | Water content approx. 3% |
| MS 255/5: | with 0.9% malic acid | Water content approx. 3% |

The glass bodies according to the invention of Group I were produced with the method according to the invention, whereby the cooking temperature did not exceed 133° C. at any time.

Group II: Isomalt glass body (reference example)

| | | |
|---|---|---|
| MS 255/6: | without acid | Water content approx. 1% |
| MS 255/8: | without acid | Water content approx. 2% |
| MS 255/9: | with 0.9% malic acid | Water content approx. 1% |
| MS 255/10: | with 0.9% malic acid | Water content approx. 2% |

Group III: Sucrose/glucose syrup glass body (50:50) (reference example):

| | | |
|---|---|---|
| MS 255/14: | without acid | Water content approx. 2% |
| MS 255/15: | without acid | Water content approx. 3% |
| MS 255/16: | with 0.9% malic acid | Water content approx. 2% |
| MS 255/17: | with 0.9% malic acid | Water content approx. 3% |

### EXAMPLE 2

### Storage Test

a) Water Uptake

A storage test was carried out for a period of 3 days. The storage temperature was constant at 25° C., the humidity was constant at 80% relative humidity. The water content of the glass bodies was determined at the start of the test (0-sample) and at the end of the test. The water uptake, in units of g/100 g, was calculated. The results are shown in Table 1.

TABLE 1

| | | | MS 255/5 |
|---|---|---|---|
| | MS 255/1 | MS 255/2 | Isomaltulose |
| According to the | Isomaltulose | Isomaltulose | (3% water |
| invention | (2% water) | (3% water) | with acid) |
| Water content | 1.7 | 2.8 | 3.1 |
| 0-sample [g/100 g] | | | |
| Water uptake | 1.34 | 1.49 | 2.70 |
| [g/100 g] | | | |

| | | | MS 255/9 | MS 255/10 |
|---|---|---|---|---|
| | MS 255/6 | MS 255/8 | Isomalt | Isomalt |
| Reference | Isomalt | Isomalt | (1% water) | (2% water) |
| example | (1% water) | (2% water) | (with acid) | (with acid) |
| Water | 1.2 | 2.0 | 1.3 | 1.8 |
| content | | | | |
| 0-sample | | | | |
| [g/100 g] | | | | |
| Water uptake | 1.56 | 1.49 | 1.85 | 1.91 |
| [g/100 g] | | | | |
| | | | MS 255/16 | MS 255/17 |
| | MS 255/14 | MS 255/15 | Sucrose- | Sucrose- |
| | Sucrose- | Sucrose- | Glucose | Glucose |
| Reference | Glucose | Glucose | (2% water) | (3% water) |
| example | (3% water) | (2% water) | (with acid) | (with acid) |
| Water | 3.0 | 2.3 | 2.2 | 2.7 |
| content | | | | |
| 0-sample | | | | |
| [g/100 g] | | | | |
| Water uptake | 20.91 | 21.84 | 27.05 | 22.90 |
| [g/100 g] | | | | |

b) Isomaltulose Recovery

Moreover, the recovery of isomaltulose in the glass bodies was tested. The results of the recovery tests are shown in Table 2. Isomaltulose glass bodies with no acid added show isomaltulose recoveries in excess of 90%.

TABLE 2

| | | | MS 255/5 |
|---|---|---|---|
| | MS 255/1 | MS 255/2 | Isomaltulose |
| | Isomaltulose | Isomaltulose | (3% water) |
| | (2% water) | (3% water) | (with acid) |
| Recovery | 95.9 | 93.5 | 82.6 |
| [g/100 g | | | |
| isomaltulose | | | |
| used] | | | |

c) Structure and Organoleptic Properties

In a further test, the structure and organoleptic properties of the stored glass bodies were determined and documented by photography (see FIGS. 1a to 1f and 2a to 2f).

The isomaltulose glass bodies with no acid added (isomaltulose recovery>90%) are slightly opaque and not sticky at the surface. The isomaltulose glass bodies with acid added and a water content of approx. 3% (3.1%) are more strongly opaque, but not clearly recrystallized and do not show a “snails foot” on the Petri dish (isomaltulose recovery: 82.6%). The storage stability of the isomaltulose glass bodies strongly depends on the degree of degradation of isomaltulose and thus on the formula that is used. The shape of the isomaltulose glass bodies with an isomaltulose recovery>90% (without acid during their production) is stable, which is in contrast to the sucroseglucose syrup glass bodies. Moreover, they show a surprisingly low degree of recrystallization as compared to the isomalt glass bodies.

Moreover, it is evident that the sucrose-glucose syrup glass bodies deliquesce to a syrup during the storage tests. The isomalt glass bodies also show clear recrystallization. The isomaltulose glass bodies according to the invention containing acid recrystallize to a certain degree, but their recrystallization is lower than in the reference examples. In contrast, the isomaltulose glass bodies according to the invention without acid show basically no recrystallization under the selected conditions.

### EXAMPLE 3

### Processability

In a further test, the processability during pouring (flowability/flow behavior) of the isomaltulose-containing hard caramel mass of the caramels was compared to known hard caramel masses.

It is evident that the flow behavior of the isomaltulose mass during pouring is similar to the flow behavior of a sucrose-glucose syrup mass (see Example 1). Isomaltulose mass shows similarly good processability as known hard caramel masses.

1. Hard caramel, comprising isomaltulose in an amount of 80 to 98% by weight (relative to the total dry matter of the hard caramel).

2. Hard caramel according to claim 1, wherein the hard caramel is free of acid.

3. Hard caramel according to claim 1, wherein the hard caramel is free of fat and/or oil.

4. Hard caramel according to claim 1, wherein isomaltulose is the sole sweetener contained therein.

5. Hard caramel according claim 1, wherein the hard caramel comprises a core and a coating, whereby one of solely and the core, the coating, or the core and the coating contains isomaltulose.

6. Process for the production of an isomaltulose containing hard caramel, wherein an aqueous solution or suspension comprising isomaltulose in an amount of 80 to 98% by weight is evaporated under the action of heat, cooled down, shaped, and a hard caramel is obtained.

7. Process according to claim 7, wherein the temperature of the exposure to heat is lower than or equal to 135° C., preferably lower than or equal to 130° C., at all times.

8. Process according to claim 7, wherein the pH value of the aqueous solution or suspension is lower than or equal to 5, at all times.

9. Hard caramel, obtainable by the process according to claim 6.

10-12. (canceled)

13. Hard caramel according to claim 1 having a water content of more than or equal to 2%.

14. Hard caramel according to claim 1 having a water content of more than or equal to 3%.

15. Process according to claim 8, wherein the pH value of the aqueous solution or suspension is lower than or equal to 7 at all times.

16. Process according to claim 6, whereby the pH value of the aqueous solution or suspension is lower than or equal to 5 at all times.

17. Process according to claim 17, wherein the pH value of the aqueous solution or suspension is lower than or equal to 7 at all times.

18. Hard caramel according to claim 2, wherein the hard caramel is free of fat and/or oil.

19. Hard caramel according to claim 18, wherein isomaltulose is the sole sweetener contained therein.

20. Hard caramel according to claim 2, wherein isomaltulose is the sole sweetener contained therein.
